(19) United States
(12) Patent Application Publication
(10) Pub. No.: US 2009/0172437 A1
(43) Pub. Date: Jul. 2, 2009

(54) Power Switch and Power Supply Using the Same

(76) Inventor: Ming-Hui CHENG, Hsin-Chu (TW)

Correspondence Address: HDLS Patent & Trademark Services, P.O. BOX 220746, CHANTILLY, VA, 20153-0746, US

(21) Appl. No.: 12/108,670

(22) Filed: Apr. 24, 2008

(30) Foreign Application Priority Data
Dec. 27, 2007 (TW) 096150674

(51) Int. Cl. G06F 1/32

(52) U.S. Cl. 713/322

(57) ABSTRACT

A power switch includes a power status providing module, a trigger, and a logic circuit. The power status providing module is configured for providing a first signal when being turned on, and for providing a second signal when being turned off. The trigger is configured for providing a first logic voltage when being pushed down, and for providing a second logic voltage when being released. The logic circuit has a data input terminal, a clock input terminal and an output terminal. The data input terminal is configured for receiving the first signal and the second signal to form a data signal. The clock input terminal is configured for receiving the first logic voltage and the second logic voltage to form an operation clock. The output terminal is configured for outputting a power control signal inverse to the data signal according to the operation clock.

### BACKGROUND

1. Field of the Invention

The present invention relates to a power switch and a power supply using the same, and more specifically, to a power switch which is capable of operating effectively without a microprocessor, and a power supply using the same.

2. Description of the Related Art

Power switches are usually divided into two types, one type is electric switches, and the other type is mechanical switches. The electric switches usually employ microprocessors as control centers, and employ memories or buffers, etc., to store actual statuses. The storing statuses are changed when users press keys to change the actual statuses. However, with the rapid developing of technology, need of saving power is more and more important. Since the electric switches employ microprocessors to monitor the change of the whole status, part of the power is consumed in the standby time. Therefore, the electric switches are not capable of satisfying the need of saving power.

One method for solving the above problem is replacing the electric switches with the mechanical switches. The general mechanical switches employ springs or fasteners as switches. However, the general mechanical switches have very simple functions, since they are designed simple and have a small volume. The mechanical switches only perform pure switching operations. If adding the functions, the structures of the mechanical switches are complicated, and the costs are increased largely. They are not good selections for the manufacturers.

What is needed, is providing a power switch having a simple structure and saving power.

### BRIEF SUMMARY

The present invention is providing a power switch which has a simple structure for controlling a power supply.

The present invention is providing a power supply which employs a power switch to control the power supply without a microprocessor to save the power.

A power switch, in accordance with a preferred embodiment of the present invention, includes a power status providing module, a trigger, and a logic circuit. The power status providing module is configured for providing a first signal when the power module is turned on, and for providing a second signal when the power module is turned off. The trigger is configured for providing a first logic voltage when the trigger is pushed down, and for providing a second logic voltage when the trigger is released. The logic circuit has a data input terminal, a clock input terminal and an output terminal. The data input terminal is configured for receiving the first signal and the second signal to form a data signal. The clock input terminal is configured for receiving the first logic voltage and the second logic voltage to form an operation clock. The output terminal is configured for outputting a power control signal inverse to the data signal according to the operation clock.

A power supply, in accordance with another preferred embodiment of the present invention, includes a power module and a power switch. The power module is configured for providing a working voltage. The power switch is electrically connected to the power module, for turning on and off the power module. The power switch includes a power status providing module, a trigger and a logic circuit. The power status providing module is electrically connected to the power module for receiving the working voltage. The power status providing module is configured for providing a first signal when the power module is turned on, and for providing a second signal when the power module is turned off. The trigger is configured for providing a first logic voltage when the trigger is pushed down, and for providing a second logic voltage when the trigger is released. The logic circuit has a data input terminal, a clock input terminal and an output terminal. The data input terminal is configured for receiving the first signal and the second signal to form a data signal. The clock input terminal is configured for receiving the first logic voltage and the second logic voltage to form an operation clock. The output terminal is configured for outputting a power control signal inverse to the data signal according to the operation clock. The power control signal is outputted to the power module for turning on and off the power module.

The embodiments of the present power switch are capable of controlling the power supply without a microprocessor, thus the power switch are capable of saving the power in the standby time. Furthermore, by the simple design of circuit, the power switch has a small volume to attain the switch controlling function.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit block diagram of a power supply having a power switch, in accordance with a preferred embodiment of the present invention;

FIG. 2A is a circuit diagram of a trigger in accordance with an embodiment of the present invention;

FIG. 2B is a wave diagram of an output signal of the trigger in accordance with an embodiment of the present invention;

FIG. 3 is a circuit diagram of a power status providing module in accordance with an embodiment of the present invention; and

FIG. 4 is a circuit block diagram of a power supply having a power switch, in accordance with another preferred embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

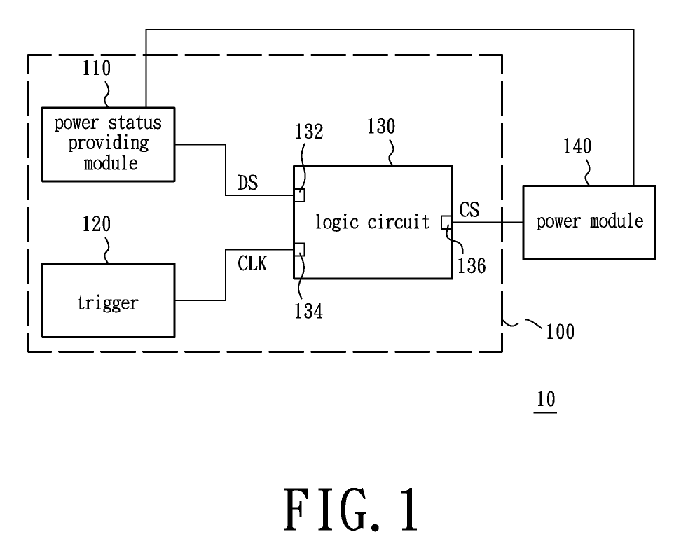

Referring to FIG. 1, a circuit block diagram of a power supply having a power switch in accordance with a preferred embodiment of the present invention is shown. In this exemplary embodiment, the power supply 10 includes a power switch 100 and a power module 140. The power switch 100 is configured for turning on or off the power module 140. The power module 140 provides a working voltage to the whole electronic device when it is turned on. Furthermore, the power module 140 also provides a standby power to a monitoring circuit when it is turned off. Of course, the standby power may be provided by another independent power supply, as known by the persons skilled in the art.

In FIG. 1, the power switch 100 includes a power status providing module 110, a trigger 120 and a logic circuit 130. The power status providing module 110 provides a first signal to the logic circuit 130 when the power module 140 is turned on, and provides a second signal different from the first signal to the logic circuit 130 when the power module 140 is turned off. The trigger 120 provides a first logic voltage to the logic circuit 130 when the trigger 120 is pushed down, and provides a second logic voltage different from the first logic voltage to the logic circuit 130 when the trigger 120 is released. The logic circuit 130 has a data input terminal 132, a clock input terminal 134 and an output terminal 136. The first signal and the second signal outputted from the power status providing module 110, are inputted into the data input terminal 132 as a data signal DS. The first logic voltage and the second logic voltage outputted from the trigger 120 are combined in sequence to form an operation clock CLK and be inputted into the clock input terminal 134. According to the operation clock CLK, the logic circuit 130 outputs a power control signal CS inverted from the data signal DS to the power module 140. The power control signal CS is configured for turning on or off the power module 140.

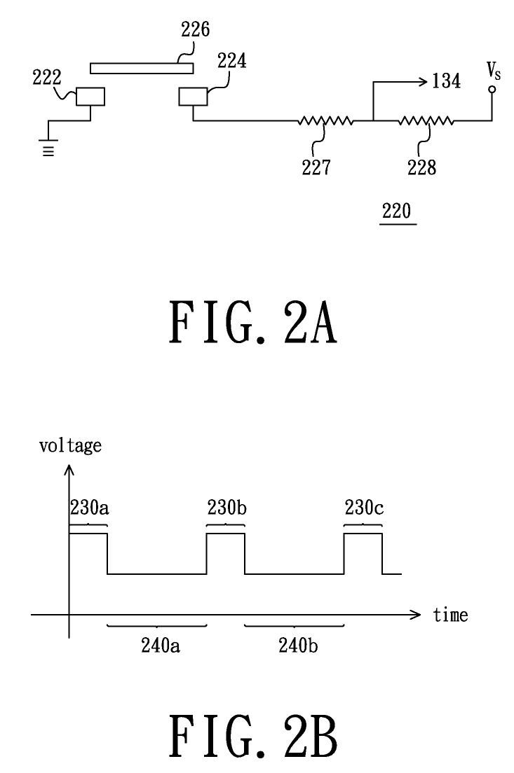

Referring to FIG. 2, a circuit diagram of the trigger 120 in accordance with an embodiment of the present invention is shown. In this exemplary embodiment, the trigger 120 in FIG. 1 denotes as 220. The trigger 220 includes a first pin 222, a second pin 224, a pressure plate 226 and two resistors 227 and 228. The first pin 222 electrically connects to the ground. The second pin electrically connects to the standby power Vs continuously provided in the standby time. One end of the resistor 227 electrically connects to the second pin 224, and another end thereof electrically connects to one end of the resistor 228 and the clock input terminal 134 as shown in FIG. 1. Another end of the resistor 228 electrically connects to the standby power Vs.

When the pressure plate 226 is pushed down, the first pin 222 electrically connects to the second pin 224 through the pressure plate 226 to make the first pin 222 electrically conduct with the second pin 224. At this time, the standby power Vs, the resistors 228, 227, the second pin 224, the pressure plate 226 and the first pin 222 form a conductive circuit. The standby power Vs is divided by the resistors 228 and 227 to provide the first logic voltage to the clock input terminal 134. When the pressure plate 226 is released, the pressure plate 226 is spaced in a distance from the first pin 222 and the second pin 224. At this time, the standby power Vs, the resistors 228, 227, the second pin 224, the pressure plate 226 and the first pin 222 do not form a conductive circuit. The second logic voltage inputted into the clock input terminal 134, is approximately equal to the voltage of the standby power Vs.

Referring to FIG. 2B, a wave diagram of the output signal of the trigger in accordance with an embodiment of the present invention is shown. The wave is a combination of the first logic voltage (in time periods 230a, 230b and 230c) and the second logic voltage (in the time periods 240a and 240b). The combination is used as the clock signal CLK by the logic circuit 130 in FIG. 1. The logic circuit 130 outputs the power control signal CS according to the clock signal CLK to turn on or off the power module 140. The first logic voltage and the second logic voltage respectively correspond to a high logic status “1” and a low logic status “0” different from the high logic status “1”. The first logic voltage corresponds to one of the high logic status “1” and the low logic status “0”, and the second logic voltage corresponds to another thereof.

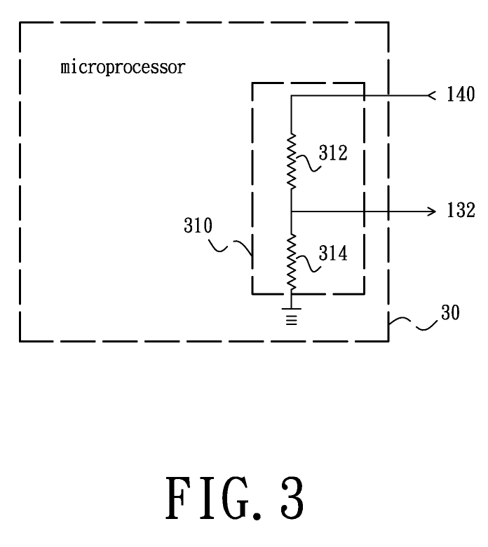

Referring to FIG. 3, a circuit diagram of the power status providing module 110 in accordance with an embodiment of the present invention is shown. The power status providing module 110 in FIG. 1 denotes 310. In this exemplary embodiment, the power status providing module 310 is arranged in the microprocessor 30. However, the persons skilled in the art know that the power status providing module 310 may also be arranged out of the microprocessor 30.

In FIG. 3, the power status providing module 310 includes two resistors 312 and 314. A first end of the resistor 312 electrically connects to the power module 140 as shown in FIG. 1 to receive the working voltage provided by the power module 140. A second end of the resistor 312 and a first end of the resistor 314 electrically connect to the data input terminal 132 as shown in FIG. 1, such that the voltage on the second end of the resistor 312 (or the first end of the resistor 314) is provided to the data input terminal 132. The second end of the resistor 314 electrically connects to the ground. According to this design, when turning on the power module 140, the resistors 312 and 314 are configured for dividing voltage to obtain the first signal, which outputs to the data input terminal 132. When turning off the power module 140, the second signal provided by the power status providing module 310 outputs to data input terminal 132. That is, the voltage of the data input terminal 132 changes to the low logic status “0”.

Please note, the power status providing module 310 may not electrically connect with the power module 140 to receive the working voltage. That is, the first terminal of the resistor 312 in the power status providing module 310 may electrically connect to any location, which has power when turning on the power module 140, or has power when turning on or off the power module 140. However, the location has different powers in two different statuses, which make the different signals (the first signal and the second signal) outputted into the data input terminal 132, correspond respectively to the different logic statuses (the high logic status “1” or the low logic status “0”). For example, the power status providing module 310 may directly connect electrically to one location of the microprocessor 30. Alternatively, the signal provided by the microprocessor 30 may be conductive to the first end of the resistor 312. Since the microprocessor 30 is supplied with the power only when turning on the power module 140, the signal provided by the microprocessor 30 to the resistor 312 presents only when turning on the power module 140. Therefore, the microprocessor 30 is easily used to control the power status providing module 310.

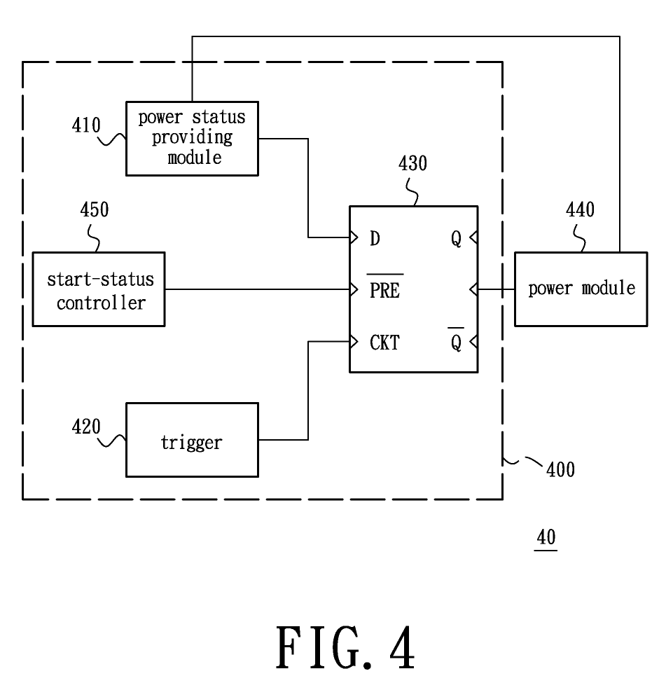

Referring to FIG. 4, a circuit block diagram of a power supply having a power switch in accordance with another preferred embodiment of the present invention is shown. The power status providing module 410, the trigger 420 and the power module 440 are same to those in FIG. 1. A flip-flop 430 is served as the logic circuit 130 as shown in FIG. 1. The flip-flop 430 has a data input terminal D corresponding to the data input terminal 132 of the logic circuit 130, a clock input terminal CKT corresponding to the clock input terminal 134 of the logic circuit 130, and an inverse data output terminal Q corresponding to the output terminal 136 of the logic circuit 130. In this circuit, the exemplary embodiment provides a following operation value list:

Operation Value List

| input | | output |
|---|---|---|
| CKT | D | Q̅ |
| Rising edge trigger | Low logic status “0” | High logic status “1” |
| Rising edge trigger | High logic status “1” | Low logic status “0” |

Furthermore, in this exemplary embodiment, the power switch 400 further includes a start-status controller 450. The start-status controller 450 electrically connects to the flip-flop 430 (of course, it can be considered that the start-status controller 450 electrically connects to the logic circuit 130) to output a start-status control signal to a reset signal terminal P̅R̅E̅ of the flip-flop 430. The start-status control signal is configured for controlling the initial status of the flip-flop 430 (or the logic circuit 130). Therefore, the power module 440 may turn on directly or keep turning off once supplying the power. To hold the initial status thereof, the standby power Vs is used to supply the power to the start-status controller 450 to holding the output.

From the above, since the present power switch needs not a microprocessor, the power switch is capable of saving the power in the standby time. Furthermore, the power switch is an electric switch, therefore, the power switch has a small volume.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power switch for turning on or off a power module, comprising:
a power status providing module, for providing a first signal when the power module is turned on, and for providing a second signal when the power module is turned off;
a trigger, for providing a first logic voltage when the trigger is pushed down; and for providing a second logic voltage when the trigger is released;
a logic circuit having a data input terminal, a clock input terminal and an output terminal, the data input terminal being electrically connected to the power status providing module for receiving the first signal and the second signal to form a data signal, the clock input terminal being electrically connected to the trigger for receiving the first logic voltage and the second logic voltage to form an operation clock by combining the first logic voltage and the second logic voltage, and the output terminal being configured for outputting a power control signal inverse to the data signal according to the operation clock.

2. The power switch as claimed in claim 1, wherein the logic circuit comprises a flip-flop having a data input terminal, a clock input terminal and an inverse data output terminal, wherein the data input terminal of the flip-flop is served as the data input terminal of the logic circuit, the clock input terminal of the flip-flop is served as the clock input terminal of the logic circuit, and the inverse data output terminal is served as the output terminal of the logic circuit.

3. The power switch as claimed in claim 1, wherein the trigger comprises:
a first pin electrically connected to the ground;
a second pin, electrically connected to one end of a first resistor, wherein another end of the first resistor is electrically connected to the clock input terminal of the logic circuit and one end of a second resistor, and another end of the second resistor is electrically connected to a standby power; and
a pressure plate, for being electrically connected to the first pin and the second pin to make the first pin conduct with the second pin when the pressure plate is pushed down.

4. The power switch as claimed in claim 1, further comprising a start-status controller electrically connected to the logic circuit, for outputting a start-status control signal to the logic circuit for controlling an initial status of the logic circuit.

5. The power switch as claimed in claim 1, wherein the power status providing module comprises:
a first resistor, a first end of the first resistor being electrically connected to the power module for receiving a power provided from the power module, and a second end of the first resistor being electrically connected to the data input terminal; and
a second resistor, a first end of the second resistor being electrically connected to the first end of the first resistor, and a second end of the second resistor being electrically connected to the ground.

6. The power switch as claimed in claim 5, wherein the power status providing module is arranged in a microprocessor.

7. A power supply, comprising:
a power module for providing a working voltage; and
a power switch electrically connected to the power module, the power switch being configured for turn on or off the power module, the power switch comprising:
a power status providing module electrically connected to the power module for receiving the working voltage, the power status providing module being configured for providing a first signal when the power module is turned on, and for providing a second signal when the power module is turned off;
a trigger, for providing a first logic voltage when the trigger is pushed down, and for providing a second logic voltage when the trigger is released;
a logic circuit having a data input terminal, a clock input terminal and an output terminal, the data input terminal being electrically connected to the power status providing module for receiving the first signal and the second signal to form a data signal, the clock input terminal being electrically connected to the trigger for receiving the first logic voltage and the second logic voltage to form an operation clock by combining the first logic voltage and the second logic voltage, and the output terminal being configured for outputting a power control signal inverse to the data signal according to the operation clock;
wherein the power control signal is outputted to the power module for turning on and off the power module.

8. The power supply as claimed in claim 7, wherein the logic circuit comprises a flip-flop having a data input terminal, a clock input terminal and an inverse data output terminal, wherein the data input terminal of the flip-flop is served as the data input terminal of the logic circuit, the clock input terminal of the flip-flop is served as the clock input terminal of the logic circuit, and the inverse data output terminal is served as the output terminal of the logic circuit.

9. The power supply as claimed in claim 7, wherein the trigger includes:
a first pin electrically connected to the ground;
a second pin, electrically connected to one end of a first resistor, wherein another end of the first resistor is electrically connected to the clock input terminal of the logic circuit and one end of a second resistor, and another end of the second resistor is electrically connected to a standby power; and
a pressure plate, for being electrically connected to the first pin and the second pin to make the first pin conduct with the second pin when the pressure plate is pushed down.

10. The power supply as claimed in claim 7, further comprising a start-status controller electrically connected to the logic circuit, for outputting a start-status control signal to the logic circuit for controlling an initial status of the logic circuit.

11. The power supply as claimed in claim 7, wherein the power status providing module comprises:
a first resistor, a first end of the first resistor being electrically connected to the power module for receiving a power provided from the power module, and a second end of the first resistor being electrically connected to the data input terminal; and
a second resistor, a first end of the second resistor being electrically connected to the first end of the first resistor, and a second end of the second resistor being electrically connected to the ground.

12. The power supply as claimed in claim 11, wherein the power status providing module is arranged in a microprocessor.

13. The power supply as claimed in claim 7, further comprising a microprocessor, wherein the power status providing module is arranged in the microprocessor, and the microprocessor makes the power status providing module provide the first signal when the power module is turned on, and makes the power status providing module provide the second signal when the power module is turned off.
